(19) United States
(12) Patent Application Publication
(10) Pub. No.: US 2008/0041975 A1
(43) Pub. Date: Feb. 21, 2008

(54) Painter's holster

(76) Inventor: Howard King Sears, Kill Devil Hills, NC (US)

Correspondence Address: BRADLEY D. GOLDIZEN, 505 SOUTH INDEPENDENCE BOULEVARD, SUITE 102, VIRGINIA BEACH, VA, 23452, US

(21) Appl. No.: 11/499,197

(22) Filed: Aug. 4, 2006

(51) Int. Cl. B05B 9/01

(52) U.S. Cl. 239/526; 239/152

(57) ABSTRACT

A holster for use in securing a paint gun includes a base having openings through which a belt is threaded. The holster preferably includes a t-rail receptacle for accepting a complementary t-rail of a coupler. The coupler fastens about a supply hose and includes a ring having an opening through which a hook on the spray gun passes for detachably securing the paint gun to the coupler. The coupler may be detached from the base by disengaging the t-rail from the t-rail receptacle by sliding the coupling in an upward direction. The coupler provides a device for securing both the spray gun and the supply hose to the leg, hip or waist of the user. Stress relief is also provided to the hose while the user is painting with the spray gun.

There are no related patent applications.

The subject matter of the present invention did not receive federal government research and development funding.

### BACKGROUND OF THE INVENTION

The present invention generally relates to a holster for securing a spray gun and a portion of a hose that supplies one of paint, air or both. More particularly, the invention relates to a holster comprising a detachable coupler that is secured to a supply hose for the spray gun. The holster allows the user to easily carry and use a spray gun while climbing or standing on a ladder. Simultaneously, the coupler provides stress relief to the hose between the waist of the user and an air and/or a paint supply to aid in the handling of the spray gun.

In recent years, many painters began using paint guns that pressurize paint to apply the paint during a painting process. This process typically includes a spray gun which is coupled to a paint source or pressurizing unit through a hose. This hose is heavy when extending from a ground surface to a top of a ladder or scaffolding and tends to pull a painter off-balance when working at tall heights. Being off-balance may result in sustaining an injury incurred as a result of falling from the ladder. Other injuries, such as arm strain, may be sustained by overextending the arm while supporting the weight of the hose at substantial heights.

The present invention is a holster for use with the aforementioned spray guns and aids one in transporting them to an elevated height. Moreover, the present invention secures the supply hose to the waist of the user to redistribute the weight of the hose from the user's arm to his waist. The redistribution of weight advantageously stabilizes the user when using a spray gun at an elevated height.

### SUMMARY OF THE INVENTION

The present invention is a painter's holster comprising a belt attachment unit that comprises a detachable hose coupler. The belt attachment unit includes two belt openings for accepting a belt secured about an area of the user's body, such as the waist. The belt attachment unit may be a unitary formed unit comprising a light-weight, sturdy material such as composite or rigid plastic material. The belt attachment unit may further include a block that comprises a t-rail receptacle and includes an opening arranged at a top of the t-rail receptacle and a closed bottom.

A hose coupling includes two halves for surrounding a portion of the hose. One half of the coupling includes a sturdy material formed in the shape of a ring for accepting a hook arranged on a spray gun to allow hands-free transportation of the spray gun. The other half of the coupling includes a t-rail for mating with the t-rail receptacle. Each half comprises an overlapping ear when the coupling is closed. Each ear comprises an opening through which a removable fastener extends. In this manner, the hose coupler surrounds and is fastened to a portion of a hose. The t-rail inserts through an opening in the t-rail receptacle to couple the hose to the belt attachment unit. The hose is easily disengaged by sliding the coupling upwards to disengage the t-rail from the t-rail receptacle.

It is an object of the invention to provide a holster for carrying a spray gun and relieving weight stress associated with a weight of a hose and which is exerted upon one's arm during use of the spray gun.

It is a further object of the invention to provide a holster that comprises a coupling that detachably fastens a hose to a body area of a user. The coupling is easily detached from a belt member surrounding the body area of the user.

It is a further object of the invention to provide a novel holster that provides stress relief to one's arm when using a spray gun that applies paint.

It is a further object of the invention to provide a holster for carrying a spray gun and providing stress relief associated with a weight of a hose while allowing the spray gun and hose to instantly be decoupled from the user to prevent a user from being pulled from a ladder or scaffolding.

The above and further objects, details and advantages of the invention will become apparent from the following detailed description, when read in conjunction with the accompanying drawings.

### BRIEF DESCRIPTION OF THE DRAWINGS

FIG. 1 is an elevation view of the painter's holster and showing it coupled to a hose.

FIG. 2 is a plan view of FIG. 1 taken from above and showing a hose taken in cross-section.

FIG. 3 is a perspective view of a base unit for the painter's holster.

FIG. 4 is a perspective view of a coupler unit supporting a hose therein.

FIG. 5 is a perspective end view of the coupler unit of FIG. 4 without the hose.

FIG. 6 is a perspective view of the coupler unit from a hinged side and shown in an open position.

FIG. 7 is a plan view showing the coupler in an open position from a hinged side.

FIG. 8 is a perspective view of the coupler in an open position from an interior side that contacts an exterior edge of a hose member.

FIG. 9 is a perspective view showing the holster both carrying a spray head and being arranged on a waist area of a user.

FIG. 10A is a perspective view of a user carrying both a hose and spray gun up a ladder.

FIG. 10B is a view of a user using the spray gun while the hose is secured about his waist.

### DETAILED DESCRIPTION OF THE INVENTION

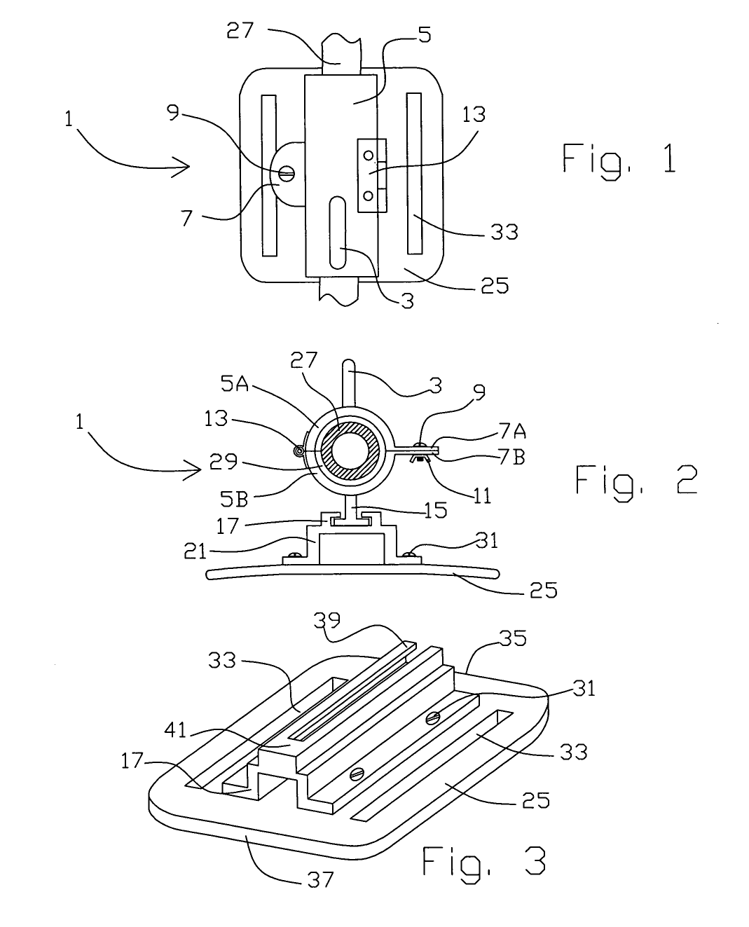

FIGS. 1 and 2 show respective views of the invention secure to a hose. A painter's holster 1 includes a ring 3 arranged on a first half or “outside” coupler half 5A of a cylindrical coupler 5. In this embodiment, the ring 3 is formed as a part of the outside coupler half 5A. A t-rail 15 is arranged on an exterior side of a second half or “inside” coupler half 5B. The cylindrical coupler 5 fastens about the hose 27 to secure it to a belt base 25 which includes belt openings 33 for accepting a belt that passes around a body part of a user such as a waist.

The coupler 5 comprises halves 5A and 5B which are fastened together via hinge 13 and fastener combination 9, 11. Each coupler half 5A, 5B is an elongated member that is curved and includes overlapping ears 7A, 7B, collectively referred to as 7 in FIG. 1. Each overlapping ear 7A, 7B includes an opening 43 for accepting a fastener 9. In this manner, the coupler 5 may be opened and a hose 27 may be seated therein. The coupler 5 is closed around the hose 27 and the fastener 9 is passed through the openings 43 of the overlapping ears 7 to secure the hose 27 within the coupler 5. The coupler 5 is preferably formed from metal or other rigid material that exhibits durability qualities. The coupler 5 fastens to the belt base 25 as discussed hereinafter and includes an internal surface or surfactant 29 for preventing the hose 27 from sliding.

The ring 3 is preferably arranged at a lower elevation than either the overlapping ears 7. As shown in FIG. 2, the fastening assembly comprises a screw 9 and a wing nut 11. However, it should be noted that other fastening means may be substituted for the screw 9 and wing nut 11. That is, various other release mechanisms may be substituted for the preferred fastening assembly set forth herein.

Arranged on a side opposite each overlapping ear 7A, 7B of the coupler 5 is the hinge 13 that couples the two halves of the coupler 5 together. The coupler halves 5A, 5B are arcuate in shape when taken in plan from above. Each coupler half 5A, 5B includes substantially 180 degrees, such that when the couplers are push together, a cylinder is formed. The t-rail 15 comprises a connecting member 75 and a support member 77. Connecting member 75 extends through an elongated opening 87 of a t-rail receptacle 17, as shown in FIG. 3. The coupler 5 is detachably fixed to the belt base 25 when t-rail 15 is slid into the t-rail receptacle 17. The t-rail 15 is arranged on an exterior side of a second half or “inside” coupler half 5B, as discussed hereinafter. In this arrangement, the coupler 5 may be quickly disengaged from the belt base 25 which is coupled to the user, by pulling upwards on any one of the hose 27, the coupler 5, or a spray gun 45 to disengage the t-rail 15 from the t-rail receptacle 17. The support member 77 is broader in width than the opening 87 and mates with opening 74 if the t-rail receptacle 17. Sides 88A and 88B form opening 87. The t-rail receptacle 17 includes block 21 which is fastened to the belt base 25 via fasteners 31. The t-rail receptacle 17 includes a closed bottom 41 and an open top 39, as shown in FIG. 3. The block 21 may be formed from a single piece of aluminum or other such light-weight metal. The belt base 25 is preferably formed from cow-hide for durability and comprises a top 35 and a bottom 37 that is oriented with respect to the user.

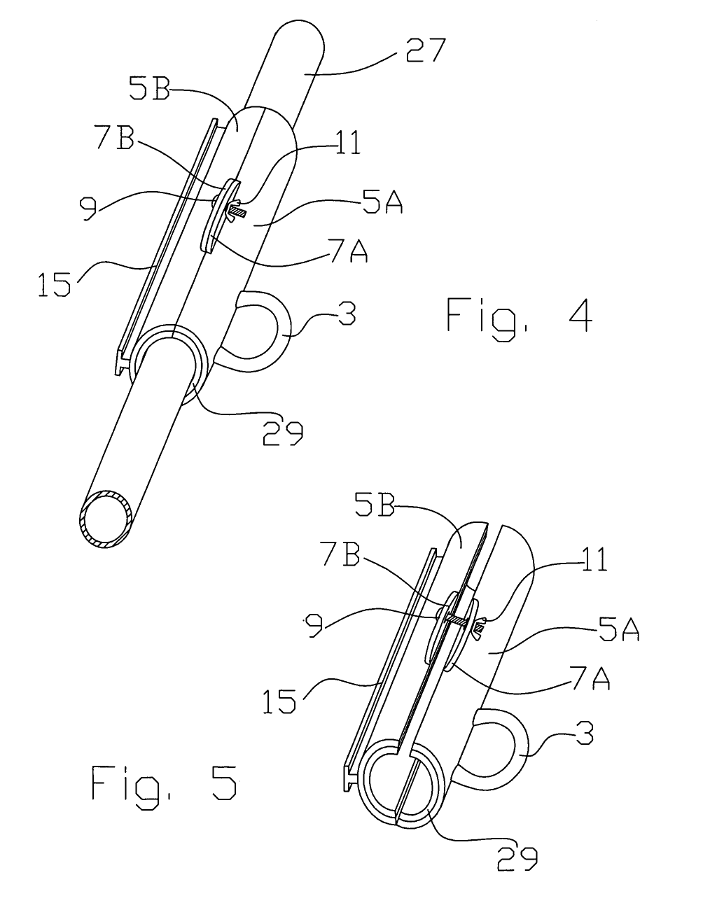

FIGS. 4 and 5 show perspective end views of the coupler 5 with and without a hose 27, respectively. Each half of the coupler 5A, 5B includes internal surface 29 which exhibits a high co-efficient of friction to prevent the hose 27 from slipping through the coupler 5. This internal surface or surfactant may comprise neoprene, rubber, silicon or other such material. As shown in FIG. 5, the wing nut 11 may be loosed from the screw 9 to separate or open the halves 5A, 5B of the coupler 5 to allow hose 27 to be inserted therein.

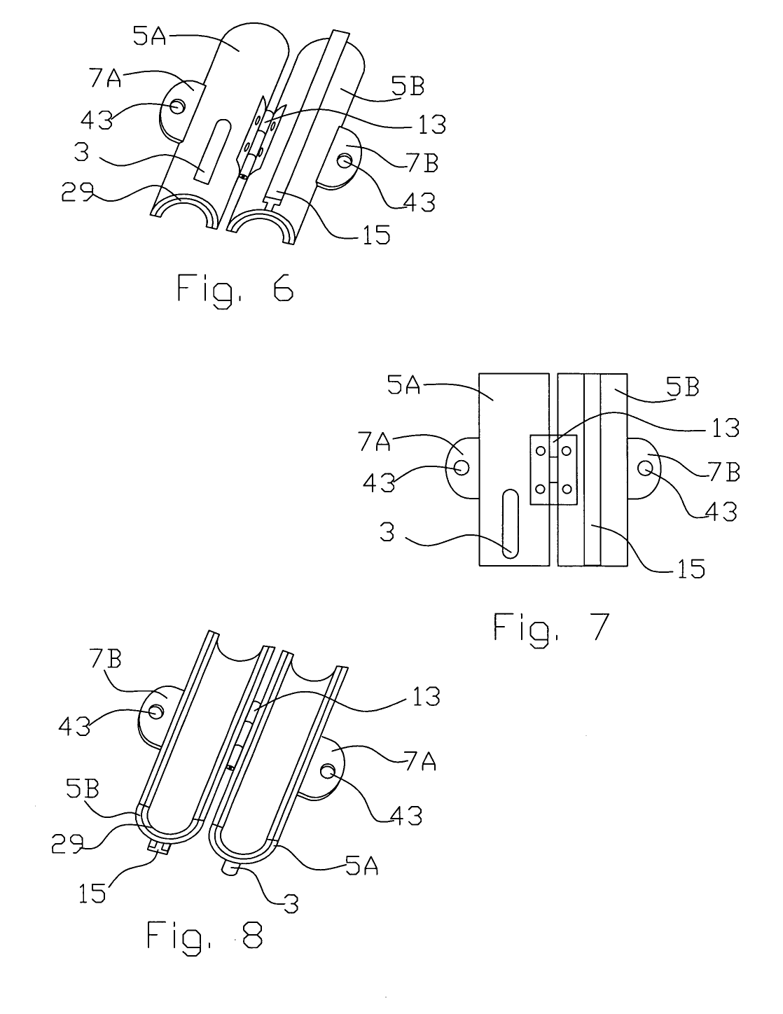

FIG. 7 is a plan view of the coupler shown from a hinged side of the coupler 5. As can be seen, each coupler half 5A, 5B includes overlapping ear 7A, 7B that comprises an opening 43 through which the fastener device extends to secure one side of each of the halves together. As shown in FIGS. 6-8, each half 5A, 5B includes an arcuate region for surrounding an exterior of hose 27. On coupler half 5A, ear 7A is arranged on an opposite exterior side from hinge 13. Ring 3 is arranged on the exterior side of the coupler half 5A at substantially equal distance between ear 7A and hinge 13. In terms of degrees, the hinge 13 is arranged substantially at zero degrees; ring 3 is arranged at substantially ninety degrees; and, ear 7A is arranged at substantially one-hundred eighty degrees. On coupler half 5B, ear 7B is arranged at substantially zero degrees; t-rail 15 is arranged at substantially ninety degrees; and, hinge 13 is arranged at substantially one hundred eighty degrees.

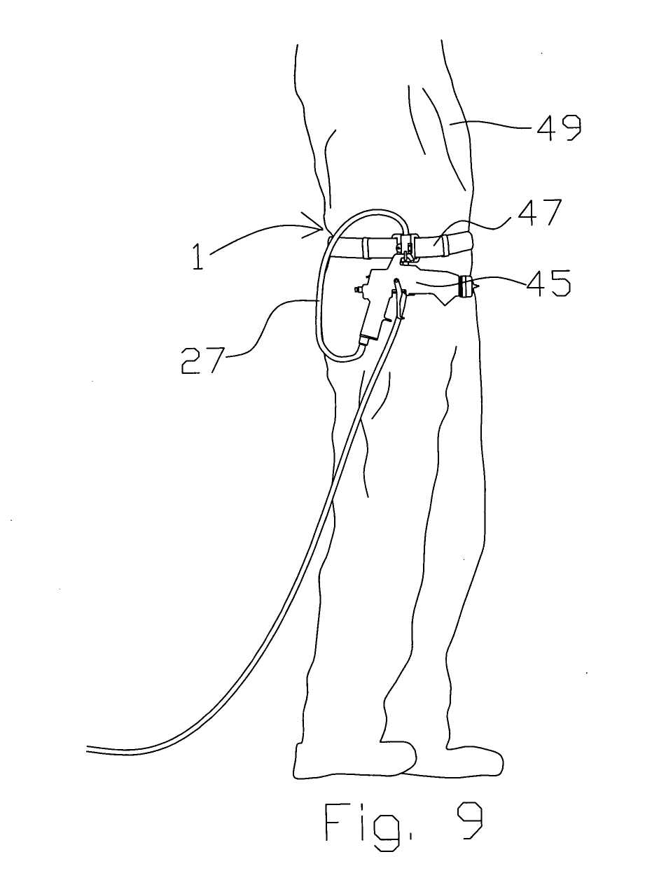

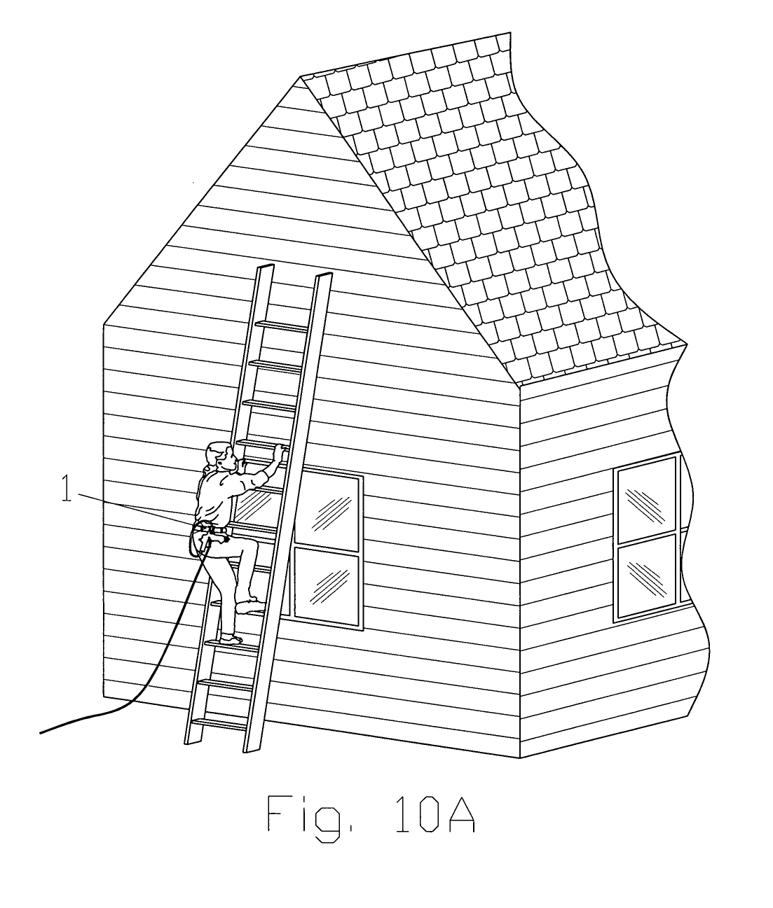

FIG. 9 shows the holster 1 with a spray gun 45 and hose 27 attached thereto. The hose 27 is held as shown in FIG. 1 at a distance from the spray gun 45 to allow a loop of hose to be created as shown. The holster 1 is secured to the waist of the user via belt 47 which passes through belt openings 33. From the discussion it is clear in this position, the both the hose 27, coupler 5 and spray gun 45 is quickly disengaged from the user by pulling any one of them upward to disengage the t-rail 15 from the t-rail receptacle 17.

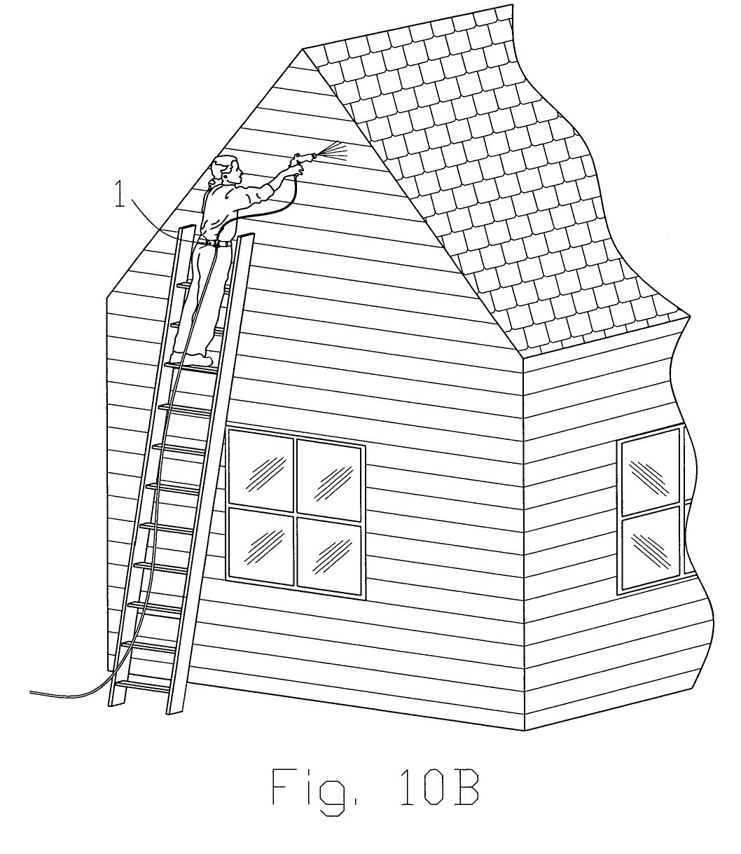

FIG. 10A shows the holster 1 in use where the spray gun 45 and the hose 27 are both secured about a waist of the user. FIG. 10B shows the holster 1 in use and relieving arm stress associated with a weight of the hose that extends between the user and a paint supply (not shown). In this figure, the user has disengaged the spray gun 45 from the ring 3 for use in painting a house. Should the need arise, the user may quickly disengage the hose 27 and coupler 5 from his waist by disengaging the t-rail from the t-rail receptacle as mentioned previously.

While the invention has been described with respect to preferred embodiments, it is intended that all matter contained in the above description or shown in the accompanying drawings shall be interpreted as illustrative and not in limiting sense. From the above disclosure of the general principles of the present invention and the preceding detailed description, those skilled in the art will readily comprehend the various modifications to which the present invention is susceptible. Therefore, the scope of the invention should be limited only by the following claims and equivalents thereof.

I claim:

1. A painter's holster comprising:
a belt base that includes a t-rail receptacle and a pair of belt openings that receive a belt that couples the belt base to a user;
a coupler that comprises a first half and a second half, each half including an interior surface and an exterior surface, the interior surface of each half including a surfactant exhibiting a high co-efficient of friction, the exterior surface of the first half comprising a ring for securing a spray gun and said exterior surface of the second half comprising a t-rail for mating with the t-rail receptacle of the belt base, each of said first and second half including an overlapping ear that includes an opening that receives a fastener therethrough; and
a hinge coupling the first half and the second half of the coupler together such that the fastener may be removed from the openings in the overlapping ears to allow a hose to be arranged within the coupler.

2. The painter's holster of claim 1 wherein said fastener is a screw and nut assembly.

3. The painter's holster of claim 1 wherein said t-rail receptacle comprises an open top.

4. The painter's holster of claim 1 wherein said ring for securing the spray gun is arranged a substantially equal distance between said hinge and said overlapping ear.

5. The painter's holster of claim 1 wherein said t-rail is arranged at a substantially equal distance between said hinge and said overlapping ear.

6. The painter's holster of claim 1 wherein said belt base comprises leather.

7. The painter's holster of claim 1 wherein said t-rail receptacle comprises a block that is fastened to the belt base via a threaded fastener.

8. The painter's holster of claim 1 wherein said painter's holster further comprises a spray gun fastened through said ring and a hose arranged within said coupler such that a loop of hose is created between the spray gun and an interior surface of the coupler.

9. A painter's holster that secures a hose and a spray gun for carrying both up a ladder, said spray gun and said hose being coupled to a wearer of the painter's holster such that the spray gun may be independently disengaged from the painter's holster without of disengaging the hose from the holster or both the spray gun and the hose may be disengaged simultaneously from the holster with one movement of a wearer's hand, said painter's holster comprising:
a belt base that includes a block fastened thereto, said block comprising a t-rail receptacle, said belt base further comprising a pair of belt openings that receive a belt to couples the belt base to the wearer; and,
a coupler having an interior surface and an exterior surface and that includes a fastener for opening and closing said coupler to allow a paint supply hose to be arranged within said coupler, a t-rail being arranged on the exterior surface of the coupler for mating with the t-rail receptacle.

10. The painter's holster of claim 9 wherein said interior surface of the coupler includes a surfactant that exhibits a high co-efficient of friction.

11. The painter's holster of claim 9 wherein said coupler comprises two halves coupled together by a hinge.

12. The painter's holster of claim 9 wherein the exterior surface of the coupler further comprises a ring for securing a spray gun thereto.

13. The painter's holster of claim 9 further comprising coupler that includes a pair of overlapping ears, each ear including an opening that receives the fastener therethrough.

14. The painter's holster of claim 9 wherein said fastener is a screw and nut assembly.

15. The painter's holster of claim 9 wherein said t-rail receptacle comprises an open top.

16. The painter's holster of claim 9 wherein said belt base comprises leather.

17. A paint system for painting an object not at ground level, said painting system comprising:
a spray gun that sprays pressurized paint onto said object, said spray gun including a hook;
a paint supply hose coupled to said spray gun for moving paint from a paint supply source to said spray gun;
a painter's holster comprising a belt base that includes a block fastened thereto, said block comprising a t-rail receptacle, said belt base further comprising a pair of belt openings that receive a belt to couples the belt base to the wearer, said painter's holster further comprising a coupler having an interior surface and an exterior surface and that includes a fastener for opening and closing said coupler to allow a paint supply hose to be arranged within said coupler, a t-rail being arranged on the exterior surface of the coupler for mating with the t-rail receptacle.

18. The paint system of claim 17 wherein said interior surface of the coupler includes a surfactant that exhibits a high co-efficient of friction.

19. The paint system of claim 17 wherein said coupler comprises two halves coupled together by a hinge.

20. The paint system of claim 17 wherein the exterior surface of the coupler further comprises a ring for securing the spray gun thereto.
